(19) United States
(12) Patent Application Publication
(10) Pub. No.: US 2023/0019742 A1
(43) Pub. Date: Jan. 19, 2023

(54) CUTTER SYSTEM FOR AN ELECTRIC BEARD TRIMMER

(71) Applicant: Braun GmbH, Kronberg (DE)

(72) Inventors: Xiaolan Xu, Oberursel (DE); Roman Roeder, Usingen (DE); Andreas Peter, Kronberg (DE)

(21) Appl. No.: 17/864,525

(22) Filed: Jul. 14, 2022

(30) Foreign Application Priority Data
Jul. 15, 2021 (EP) 21185864.2

(51) Int. Cl. B26B 19/06; B26B 19/38

(52) U.S. Cl. CPC B26B 19/063; B26B 19/3846

(57) ABSTRACT

The present invention relates to cutting body hair such as beard stubbles of multidays' beard. More particularly, the present invention relates to a cutter system for an electric shaver and/or trimmer, comprising an inner cutting element and an outer cutting element forming a pair of cooperating cutting elements with at least one row of comb-like outer cutting teeth extending parallel to a first axis (I), wherein said cutting elements are movably supported relative to each other. Skin irritation may be reduced by the at least one row of comb-like outer cutting teeth having, at a position of 0.2 mm away from the tip, a ratio between tooth width in a direction perpendicular to said first axis (I) and width of an opening slot between two adjacent teeth between 1.0 and 2.0.

### FIELD OF THE INVENTION

The present invention relates to cutting body hair such as beard stubbles of multidays' beard. More particularly, the present invention relates to a cutter system for an electric shaver and/or trimmer, comprising a pair of cooperating cutting elements with at least one row or two rows of comb-like cutting teeth, wherein said cutting elements are movably supported relative to each other. For example, said cutting elements may be movably supported relative to each other by a support structure. At least one of said cutting elements, when viewed in cross section, may have a C-shape including a pair of dog-eared holding flanges attached to said support structure and a slightly dome shaped or flat center section, said row of comb-like cutting teeth being formed in a transitional section between said dog-eared holding flanges and said center section. Two rows of comb like cutting teeth are arranged relative to each other with the tooth tips facing away from each other.

### BACKGROUND OF THE INVENTION

Electric shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating cutting elements with comb-like edges including one or more rows of comb-like or rake-like cutting teeth reciprocating or rotating relative to each other, are often used for cutting longer beard stubbles or problem hair that is difficult to cut due to, for example, a very small angle to the skin or growing from very resilient skin. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric shavers or trimmers which at the same time may be provided with the aforementioned shear foil cutters.

For example, EP 2 425 938 B1 shows a shaver with a pair of long hair trimmers integrated between shear foil cutters. Furthermore, EP 2 747 958 B1 discloses a hair trimmer having two rows of cooperating cutting teeth arranged at opposite sides of the shaver head.

In such cutter systems safety and skin comfort is an important aspect. Especially, it is intended avoiding that the tooth tips of the cutting teeth go into the hair follicles and/or that a skin bulge is entering the opening slot between the cutting teeth and may touch the moving cutting element. In this respect, EP 2 747 958 B1 proposes providing the cutting teeth of the upper comb-like cutting element with rounded and thickened tooth tips overhanging the tooth tips of the lower cutting element so as to prevent the projecting tooth tips from piercing into the skin and from irritating the skin.

A similar cutter system is shown in US 2017/0050326 A1 wherein in such cutter system the lower comb-like cutting element is fixed and the upper comb-like cutting element is movable.

As of the date of first filing this unpublished European patent application No 20173681.6 proposes a trimmer combining rows of comb-like cutting teeth at opposite edges and shear foil-like cutting perforations between said rows of comb-like teeth. These teeth are formed by C-shaped outer cutting elements the edges of which are dog-eared to form limbs bent inwardly like the limbs of a C or a U, wherein such dog-eared limbs are held by a support frame. The transitional edge portion connecting the dog-eared limbs with the central portion of the outer cutting element is contoured or configured to form a row of comb-like teeth for cutting longer stubbles, whereas the central portion of the cutting element is provided with at least one field of perforations for cutting short hair. The teeth have thinned out tooth tips which are formed, in cross section, U-shaped and/or include neighboring portions of a holding flange and a center section which are folded back-to-back onto each other to form, in cross section, U-shaped tooth tips. These tooth tips are rounded, i.e. the tip portion is smaller in width compared with the rest of the respective tooth.

### SUMMARY OF THE INVENTION

It is an objective underlying the present invention to provide for an improved cutter system avoiding at least one of the disadvantages of the prior art and/or further developing the existing solutions. A more particular objective underlying the invention is to provide for a close and thorough cutting of hair and longer stubbles including a good control of edging contours and, at the same time, avoiding skin irritations. Another objective underlying the present invention is a reliable and clean cutting action of the cooperating cutting teeth and cutting perforations to avoid pulling and tugging of hair.

According to an aspect of the present invention, a pleasant skin feel avoiding skin irritations may be achieved by a cutter system for an electric shaver and/or trimmer with an improved geometry of an outer cutting element and in particular with respect to the tooth tip shape thereof. In particular, in a cutter system comprising an inner cutting element and an outer cutting element forming a pair of cooperating cutting elements with at least one row of comb-like outer cutting teeth, each tooth extends parallel to a first axis. The at least one row of comb-like outer cutting teeth may have, at a position of 0.2 mm away from the tip, a ratio between tooth width in a direction perpendicular to said first axis and width of an opening slot between two adjacent teeth between 1.0 and 2.0 or between 1.05 and 1.5. In addition, or in the alternative, said outer cutting teeth may comprise tooth tips formed, in a cross section perpendicular to said first axis, in a substantially rectangular shape with planar side faces and rounded edges (also 0.2 mm away from the tooth tip along the first axis). Further alternatively or in addition the teeth of the outer cutter may comprise a flat upper surface and a flat surface parallel to that but on side away from the skin side. Cutting elements may include two rows of comb-like cutting teeth arranged, for example, at opposite sides of the cutting elements and a field of shear foil-like cutting perforations between said rows of comb-like cutting teeth. Two rows of comb like cutting teeth are arranged relative to each other with the tooth tips facing away from each other.

More particularly, said at least one row of comb-like outer cutting teeth may have, at a position of 0.2 mm away from the tip, a ratio between tooth width in a direction perpendicular to said first axis and width of an opening slot between two adjacent teeth between 1.085 and 1.433, preferably about 1.333.

In other words, it has been found that certain reasons for skin irritations, like skin injuries due to a skin bulge entering the slot between two adjacent teeth and being cut by a moving cutter element, may be prevented by a combination of a rectangular shape of the tooth tip with planar side faces and rounded edges and a ratio of about 4:3 between tooth width is and width of an opening slot between two adjacent teeth. That is to say, the tooth tips according to the present invention are not provided with rounded and thickened tooth tips overhanging the tooth tips or a drop-shaped or pearl-shaped thickening as proposed in the prior art.

This improved geometry of the outer cutting element prevents that the tooth tip goes into hair follicles. In addition, a skin bulge caused due to contact of the outer cutting element with the user's skin is more evenly distributed to avoid big skin bulge entering into the opening slot and touching the inner cutting element, i.e. the moving blade.

These and other advantages become more apparent from the following description giving reference to the drawings and possible examples.

### BRIEF DESCRIPTION OF THE DRAWINGS

FIG. 1: a perspective front side view of an electric beard trimmer/shaver including a cutting system with a pair of cooperating comb-like cutting elements reciprocating relative to each other,

FIG. 2: a perspective view of the beard trimmer of FIG. 1 working on a chin,

FIG. 3: an exploded perspective view of the elements of the cutter system including the outer and inner cutting elements,

FIG. 4: a cross sectional view of the beard trimmer/shaver showing the cooperating comb-like cutting elements and the drive system for driving said cutting elements,

FIG. 5a: a top view of the elements of the cutting system,

FIG. 5b: enlarged detail A in FIG. 5a,

FIG. 5c: a sectional view of the cutting system of FIG. 5a along line C-C,

FIG. 5d: enlarged detail B in FIG. 5c,

FIG. 5e: a perspective view of the cutting system of FIG. 5a,

FIG. 5f: enlarged detail D in FIG. 5e,

FIG. 6a: a cross sectional view of a cutting tooth along line A-A in FIG. 5,

FIG. 6b: a cross sectional view of a cutting tooth along line B-B in FIG. 5,

FIG. 7a: a sectional view of two cutting teeth according to the invention following the skin contour,

FIG. 7b: a sectional view of two prior art cutting teeth following the skin contour,

FIG. 8a: a top view of the tip of a cutting tooth according to the invention, and

FIG. 8b: a top view of the tip of a prior art cutting tooth.

### DETAILED DESCRIPTION OF THE INVENTION

So as to achieve a pleasant skin feel avoiding skin irritations, the outer cutting teeth may have, at a position of 0.2 mm away from the tip, a width of 405+/−50 μm, preferably of 405+/−25 μm. In addition or as an alternative, the outer cutting teeth may have, at a position of 0.2 mm away from the tip, a pitch of 730+/−50 μm, preferably of 730+/−25 μm. With these dimensions, a ratio of about 4:3 between tooth width and opening slot between teeth can be achieved which is favourable for preventing the tooth tip from entering into hair follicles and for an even distribution of a skin bulge, thereby avoiding a big skin bulge potentially going into the opening slot and touching the moving blade of the cutter system.

The rectangular shape of the teeth allows avoiding skin irritations. This pleasant skin feel may be increased if the outer cutting teeth have, on a side facing away from the inner cutting element, a smooth flat surface.

This geometry of the outer cutter element may be achieved by forming the outer cutting teeth, at least in a region near the respective tooth tips, e.g. at a position of 0.2 mm away from the tip, substantially U-shaped and/or including neighboring portions which are folded back-to-back onto each other to form, in cross section perpendicular to said first axis, substantially U-shaped tooth tips. in other words, the shape of the outer cutting teeth may comprising tooth tips formed, in a cross section perpendicular to said first axis, in a rectangular shape with planar side faces and rounded edges may be achieved by folding two layers of the tooth material, e.g. a flat metal sheet, onto each other. For example, the rounded edges of said tooth tips may have a bending radius e.g. between 120 μm and 225 μm. Still further, the teeth, at least at the tooth tips, may have a thickness, when viewed in cross section, of less than 1 mm or less than 0.5 mm.

For example, when a substantially C-shaped cutting element is made from a sheet-like material having a sheet thickness of 0.15 mm, the teeth may have a thickness of less than 1.5 mm, or less than 1 mm or less than 0.5 mm and/or ranging from 0.3 mm to 0.5 mm or 0.35 mm to 0.45 mm This thickness is measured at 0.3 mm, so from a point at the outermost tooth tip surface inwardly at 0.3 mm in a direction towards the opposite row of comb like cutting teeth. When viewed in cross section, said tooth tips of the comb-like cutting teeth may have a radius of curvature of less than 0.25 mm

For example, the cutting element may be formed from a metal sheet, in particular from a spring steel sheet, wherein a spring steel having a tensile strength of more than 500 N/mm² or more than 750 N/mm² may be used.

In addition to said at least one row of comb-like cutting teeth, the outer cutting element may include at least one field of perforations provided in a slightly dome-shaped or flattened center section, wherein such perforations may cut short stubbles or very short hairs entering into the perforations in a shear-foil-like way. Such cutting perforations for cutting short hair may be restricted to areas of the skin contact surface or skin facing surface of the cutting elements following the comb-like cutting teeth when the cutter system is moved along the skin to be shaved with one of the rows of comb-like teeth moving ahead, whereas a middle portion of the skin contact/facing surface defined by the cutting elements in-between said opposite rows of comb-like teeth is unperforated. Such arrangement of restricted areas of perforations separated from each other takes into account that very short hair is cut by the perforations immediately following the comb-like teeth or position close to said comb-like teeth when the cutter system is moved along the skin to be shaved in a usual manner, i.e. with one of the comb-like cutting edges moving ahead, whereas the perforations further away from the leading comb-like cutting edge are less effective in cutting very short hairs. Due to the elimination of perforations in areas of the skin contact surface less effective in cutting very short hairs reduces the friction between the cutting elements without sacrificing efficiency in cutting very short hairs. Friction is reduced as less cutting edges of less perforations need to pass each other when the cutting elements move relative to each other and, thus, hair particles already cut or hair dust coming from the cutting perforations moving ahead over the skin to be shaved is not cut or grinded once again so frictional losses are reduced. More particularly, the cutting perforations may be arranged in two separated elongated fields of perforations which are separated from each other by an elongated unperforated center section of an outer one of said cutting elements defining a skin contact surface, and which include each at least two rows of perforations extending along the rows of comb-like cutting teeth.

As cutting of hairs does not occur at the tip of the teeth, the cross section can be substantially square with a small radius at the edges. However, this geometry is not desirable for cutting hairs. Thus, the region of the tooth foot where cutting occurs preferably has a different shape in cross section. For example, said outer cutting teeth comprise a tooth root having, on a side facing away from the inner cutting element, a smooth flat surface and on a side facing towards the inner cutting element, a concave surface forming a sharp cutting edge with the side facing away from the inner cutting element. Such a contour of the teeth may be formed from a metal sheet by applying different etching techniques. For example, starting from tip to close to the moving blade tip, the tooth may be manufactured by two side etching, whereas starting from the area which is close to the moving blade tip, the tooth may be manufactured by one side etching to generate sharp edge for cutting.

The present invention further relates to a method of manufacturing a cutter element from a metal sheet comprising the steps of starting from tip to the foot, a tooth is formed by two side etching, whereas starting from the foot to the tip, the tooth is formed by one side etching. In other words, said tooth tip is formed by two side etching and said tooth root is formed by one side etching.

Still further, the present invention relates to an electric shaver and/or trimmer, comprising a cutter system which is configured as defined above.

The electric shaver and/or trimmer may comprise a movable, driven inner cutting element. The inner cutting element may be driven by a driver and coupled to a drive train transmitting a driving action of a drive unit. An inner support frame including rigid support ribs and an outer support frame including outer frame portions holding the outer cutting element and a base portion backing the inner support frame, may include one or more central, elongated or slit-like throughholes in which a portion of said driver and/or said drive train is slidably received. In other words, the driver and/or drive train extends through said throughhole in the inner and outer support frames and is slidably received therein to allow for reciprocating of the driver and thus, the inner cutting element relative to the other cutting element. The driver may include an elongated rod-like portion attached to opposite end portions of the inner cutting element and accommodated in an inner sub-chamber defined between rigid support ribs and the inner cutting element. The cutter system or a support frame thereof is supported to swivel or pivot relative to a handle portion. This further eases the adaption to different skin contours.

The inner cutting element may be the driven cutting element which may reciprocate or rotate, depending of the type of drive. Basically, each of the cooperating cutting elements may be driven. However, to combine an easy drive system with safe and soft cutting action, the upper or outer cutting element having the skin contact surface may be standing and/or may be not reciprocating and not rotating, whereas the lower or inner cutting element which may be the sandwiched cutting element, may reciprocate or rotatorily oscillate.

According to another aspect the cutter system for an electric shaver and/or trimmer comprising an inner cutting element and an outer cutting element forming a pair of cooperating cutting elements with at least one row of comb-like outer cutting teeth, each having a tooth tip and a longitudinal extension extending parallel to a first axis, a second axis which is perpendicular to the first axis defines the direction of movement of the inner cutting element with respect to the outer cutting element and a fourth axis extends perpendicular to both the first and the second axis and extends in a height direction, wherein said tooth tips of the outer teeth are shaped flat to comprise a straight line segment with a length larger than 0.15 mm parallel to axis. If the outermost tooth tip of the outer/stationary cutter is not curved as shown by the prior art view of FIG. 8b hair capture is lowered but an adverse skin bulging effect as well

According to a further aspect the length of the straight line segment is larger than 0.2 mm but smaller than 0.4 or 0.5 mm Such dimensioning assures a specifically sensitive flat tooth tip shape which avoids skin injuries by too much bulging of the skin close to the moveable cutter.

It is to be understood that the above referring to a row of comb like outer cutting teeth means at least to comprise 4 or 5 adjacent teeth 6 forming such row not necessarily all adjacent teeth of said row.

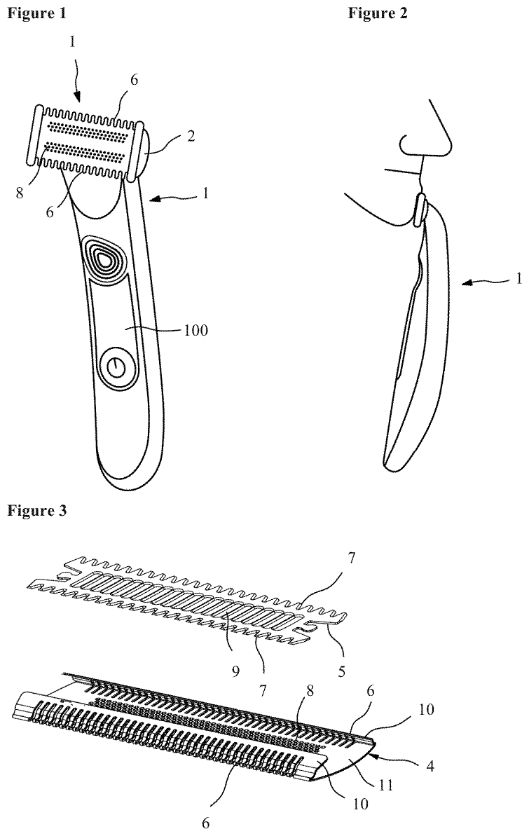

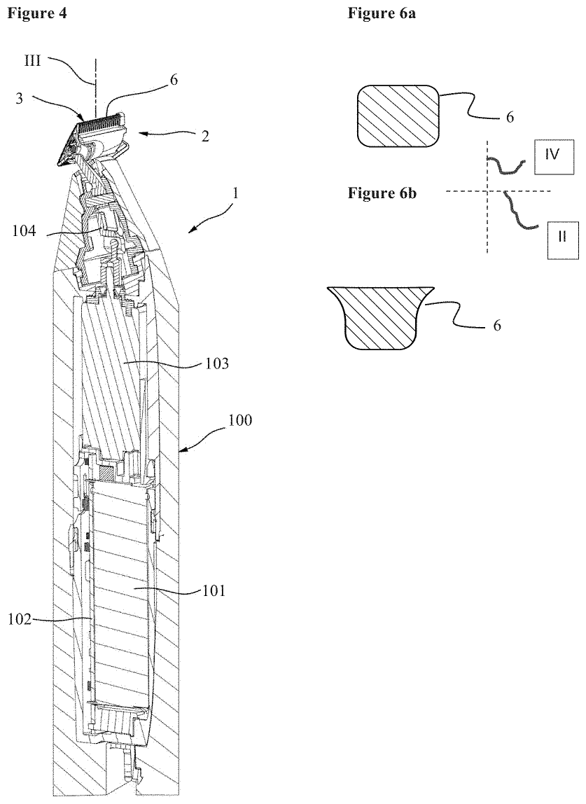

As can be seen from FIGS. 1 to 4, a shaver and/or trimmer 1 may comprise a cutter head 2 with a cutter system 3. The cutter head 2 may be attached to a handle 100 of the shaver and/or trimmer 1. More particularly, the shaver and/or trimmer 1 may include an elongated handle 100 accommodating a battery 101, electronic and/or electric components such as a control unit 102, an electric drive motor 103 or a magnetic drive motor and a drive train 104 for transmitting the driving action of the motor to the cutter system at the cutter head 2 which cutter head 2 may be positioned at one end of the elongated handle 100. The handle 100 extends substantially along an axis III (FIG. 4).

The cutter system 3 including a pair of cooperating cutting elements 4 and 5 depicted in FIG. 3 may be the only cutter system of the cutter head 2 as it is the case with the example shown in FIG. 1. On the other hand, the cutter system 3 may be incorporated into a shaver head 2, having other cutter systems such as shear foil cutters, wherein, for example, the cutter system 3 having at least one row of cooperating cutting teeth may be positioned between a pair of shear foil cutters, or, in the alternative, may be positioned in front of such a shear foil cutter.

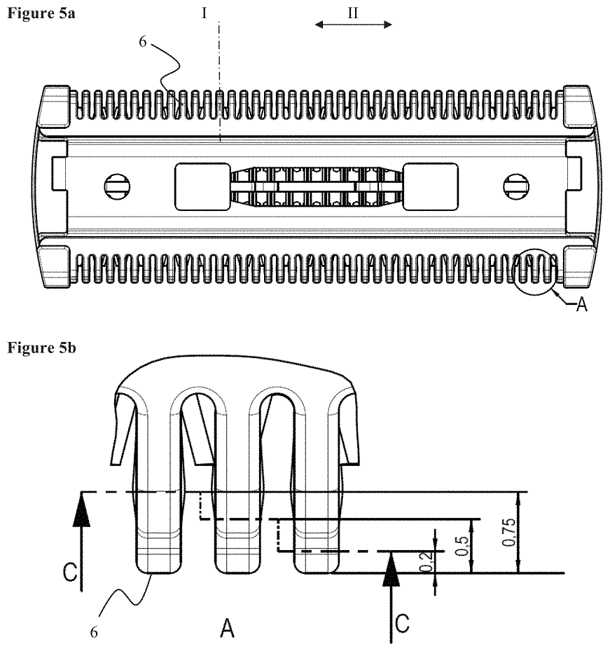

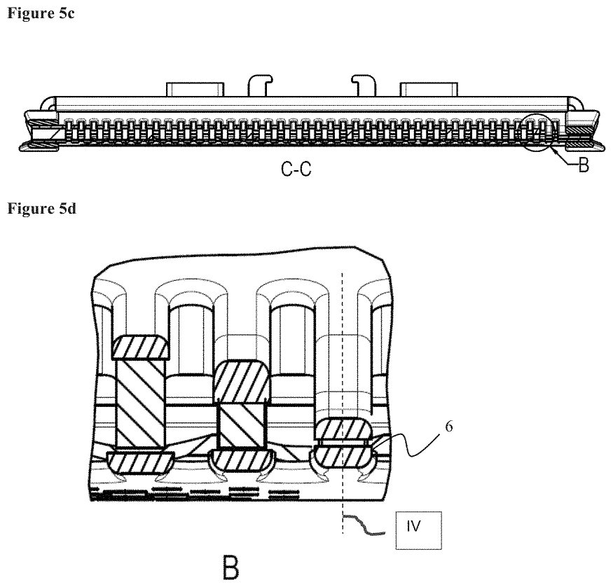

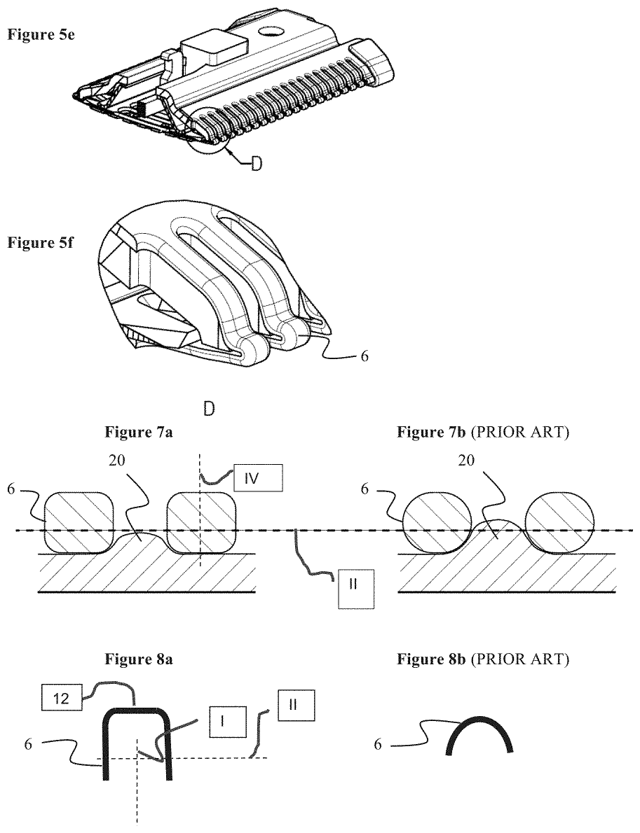

As shown in FIG. 3, the cutter system 3 may include elongated rows of cutting teeth 6 of the outer cutting element 4 and elongated rows of cutting teeth 7 of the inner cutting element 5 which may reciprocate relative to each other along a linear path so as to effect the cutting action by closing the gaps between the teeth and passing over each other. In FIG. 5a a first axis I is shown which is parallel to the teeth 6. A second axis II which is perpendicular to the first axis I defines the direction of movement of the inner cutting element 5 with respect to the outer cutting element 4.

Alternatively, the cutter system 3 also may include cutting teeth 6 and 7 which are aligned along a circle and/or are arranged radially. Such rotatory cutting elements may have cutting teeth projecting substantially radially, wherein the cutting elements may be driven to rotate relative to each other and/or to rotatorily oscillate relative to each other. The cutting action is basically similar to reciprocating cutting elements as the radially extending teeth, when rotating and/or rotatorily oscillating, cyclically close and reopen the gap between neighboring teeth and pass over each other like a scissor.

As shown in FIG. 4, the drive system may include a motor the shaft of which may rotate an eccentric drive pin which is received between the channel-like contours of a driver which is connected to one of the cutting elements 5 which is caused to reciprocate due to the engagement of the rotating eccentric drive pin with the contours of said driver. Further, as shown in FIG. 3, the cooperating cutting elements 4 and 5 basically may have—at least roughly—a plate-shaped configuration, wherein each cutting element 4 and 5 includes two rows of cutting teeth 6 and 7 which may be arranged at opposite longitudinal sides of the plate-like cutting elements 4 and 5. The cutting elements 4 and 5 are supported and positioned with their flat sides lying onto one another. More particularly, the cutting teeth 6 and 7 of the cutting elements 4 and 5 touch each other back to back like the blades of a scissor.

In addition to such comb-like cutting teeth 6 and 7, the cooperating cutting elements 4 and 5 may be provided with at least one field of cutting perforations 8 and 9 arranged between the rows of cutting teeth 6 and 7 in a middle portion of the cutting elements 4 and 5. More particularly, each field of cutting perforations 8 of the outer cutting element 4 defining a skin contact surface of the cutter system 3 may include at least two rows of perforations 8 which may be formed as small sized through holes having a circular, oval, elliptical or polygonal shape. In particular, such small sized through holes forming the perforations 8 may have a hexagonal shape, wherein the long axis of such hexagonal through holes, i.e. the axis going through opposite corners of the hexagonal shape, may be oriented transverse to the reciprocating axis II of the cutting elements 4 and 5. Cutting perforations 9 of the inner cutting element 5 may have an elongate shape as depicted in the example of FIG. 3. As an alternative, other shapes of the perforations 9 are suitable to perform cutting or shearing in a scissor-like way when the edges of the perforations 8, 9 of the cooperating cutting elements 4, 5 close the gap between the perforations and pass over each other.

The perforations 8 are not distributed all over the center section of the skin contact surface, but are arranged in limited areas only. More particularly, the cutting perforations 8 for cutting short hair are restricted to lateral areas of the skin contact surface or skin facing surface of the cutting element 4 following the comb-like cutting teeth 6 when the cutter system 3 is moved along the skin to be shaved with one of the rows of comb-like teeth 6 moving ahead, whereas a middle portion of the skin contact/facing surface defined by the cutting elements in-between said opposite rows of comb-like teeth is unperforated.

Such arrangement of restricted areas of perforations 8 spaced apart from each other takes into account that very short hair is cut by the perforations 8 immediately following the leading one of the rake-like cutting edges, whereas the perforations further away from the leading comb-like cutting edge are less effective in cutting very short hairs. Due to the elimination of perforations in areas of the skin contact surface less effective in cutting very short hairs reduces the friction between the cutting elements 4, 5 without sacrificing efficiency in cutting very short hairs. Friction is reduced as less cutting edges of less perforations need to pass each other when the cutting elements move relative to each other and, thus, hair particles already cut or hair dust coming from the cutting perforations moving ahead over the skin to be shaved is not cut or grinded once again so frictional losses are reduced.

Said elongated unperforated center section of the skin contact surface defined by the outer cutting element 4 may have a size or width which is larger than a size or width of each of said fields of perforations. More particularly, the unperforated center section of the skin contact surface may extend over an area ranging from 100%-250% or from 110% to 175% of the area defined by each of said fields of perforations. More generally, more than ⅔ or more than ¾ of the area of the skin contact surface of the cutter element 4 between the comb-like cutting teeth may be unperforated. In other words, only ¼-⅔ of the skin contact surface between the opposite rake-like toothed edges of the cutter system 3 may be perforated. Such limitation of the area of perforations 8 may significantly reduce the friction when the cutting elements 4, 5 move relative to each other.

As can be seen from FIG. 3, the outer cutting element 4, when viewed in a cross section, may have a substantially C-shaped configuration with dog-eared edge portions 10 which are bent away or curved away from the skin contact surface 11 and form holding flanges attached to or fixed to an outer frame portion of a support structure depicted in FIG. 3. Said edge portions 10 may be folded back or bent around the edge portions of said outer frame. However, in the alternative, it also would be possible to seat said holding flanges 10 of the cutting element 4 onto the inner side of said outer frame. The cutting element 4 may be rigidly or fixedly fastened to said outer frame portions. For example, the cutting element 4 may be welded or glued to the outer frame.

The cutting teeth 6 of the outer cutting element 4 may be formed in the transitional region between the folded back support flanges 10 and the front side of the cutting element 4 defining the skin contact surface 11 of the cutter system 3. As shown in FIGS. 3, 6e and 6f, said outer cutting element 4 may form a C-shaped, plate-like cutting element the edges of which are dog-eared to form limbs bent inwardly like the limbs of a C or a U. The transitional edge portion connecting the dog-eared limbs with the central portion of the outer cutting element is contoured or configured to form a row of comb-like teeth 6 for cutting longer stubbles, whereas the central portion 11 of the cutting element 4 is provided with said fields of perforations 8 for cutting short hair.

FIGS. 6c and 6d depict the two layers of material folded back-to-back onto each other to form, in cross section, the U-shaped tooth tips. At a position about 0.2 mm away from the tip, these layers together form a substantially square cross section and may be separated by a small gap as shown on the right side tooth in FIG. 5d. Proceeding towards the tooth foot, the gap increases as shown at a position about 0.5 mm away from the tip (middle tooth in FIG. 5d) and at a position about 0.75 mm away from the tip (left side tooth in FIG. 5d).

More particularly, said outer cutting teeth 6 are formed to have different cross section regions. The tooth tip, i.e. the free end facing away from the central portion 11, may have a substantially rectangular cross section with rounded edges, whereas the tooth foot, i.e. the opposite end facing towards the central portion 11, has a cross section forming a sharp cutting edge.

In more detail, FIG. 6a depicts a cross section of the tooth at a position about 0.2 mm away from the tip showing a substantially rectangle configuration in a cross section perpendicular to the first axis I. It is to be noted that this rectangle may be interrupted by a gap, so that a line or gap may be part of the rectangle extending along axis II of FIG. 6a (although not visualized in FIG. 6a). In contrast to that, FIG. 6b depicts a cross section of the tooth at a position near the transition to the central portion 11, i.e. the foot of the tooth, showing a substantially concave surface facing towards the inner cutting element 5 with a sharp cutting edge with the planar side facing away from the inner cutting element 5, i.e. the skin facing side, in FIG. 6b the lower side, is smooth and flat. In addition, as shown in FIG. 8a, the tooth 6 has a flat tip compared with the typically rounded tip (FIG. 8b) of known trimmers or shavers.

The effect of the design of the outer cutting teeth compared with prior art cutter systems is illustrated in FIGS. 7a and 7b which depict a pair of outer cutter teeth 6 in contact with the skin during use of the cutter system. While the known cutter teeth 6 with an oval cross section cause a relatively large skin bulge 20 (FIG. 7b) as the cutter system is pressed into contact with the skin during operation, the skin bulge 20 is smaller and more evenly distributed with the substantially rectangular design according to the present invention (FIG. 7a).

It is apparent that the risk of the relatively big skin bulge 20 entering the opening slot between the teeth 6 and, thus, potentially touching the moving inner cutter element 5 (not shown in FIGS. 7a, 7b) is significantly higher with the known design. This may result in abrasion of the skin bulge 20, In contrast to that, the flat skin contacting surface of the rectangular tooth tip reduces this risk due to the evenly distribution of the skin bulge 20. This results in increased skin comfort with less skin irritation.

In an example, the tooth 6 of the outer cutting element 4 as shown in FIG. 5b may have a width at the position 0.2 mm away from the tip of 405+/−25 μm. The pitch between two adjacent teeth 6 may be 730 μm, which leads to a ratio between tooth width and the opening slot between adjacent teeth of about 4:3. This prevents the tooth tip from going into hair follicles.

The thickness of the comb-like cutting teeth 6, when viewed in a cross section of the C-shaped cutting element as shown in FIGS. 5f and 6a, may be less than 300% or less than 250% of the thickness of the material forming the center section and/or dog-eared flange of the cutting element. In FIG. 6a, the thickness of the teeth 6 is the vertical dimension thereof and corresponds to the height of the tooth tips. For example, when the C-shaped cutting element 4 is made from a sheet-like material having a sheet thickness of 0.15 mm, the teeth may have a thickness of less than 0.5 mm and/or ranging from e.g. 0.2 mm or 0.24 mm or 0.3 mm to 0.5 mm, for example from 0.35 mm to 0.45 mm

The C-shaped cutting element 4 may be made from a sheet material having a substantially constant thickness. For example, the dog-eared flanges 10 may have the same material thickness as the center section 11. When viewed in cross section, said tooth tips of the comb-like cutting teeth may have a radius of curvature of less than 0.25 mm For example, the C-shaped cutting element may be formed from a metal sheet, in particular from a spring steel sheet, wherein a spring steel having a tensile strength of more than 500 N/mm² or more than 750 N/mm² may be used.

As shown in the example of FIG. 6a, the tooth tip should have a flat line 12 contacting the skin with a small radius at the edges, whereas the tooth foot should have a sharp cutting edge. The small radius may be generated by etching and bending a metal strip. Starting from tip to foot of the respective tooth 6, the tooth is manufactured by two side etching. As there is no cutting event in this area the cross section of the tooth 6 could be square with a small radius at the edges. Starting from the foot to the tip of tooth 6, the tooth is manufactured by one side etching to generate sharp edge for cutting.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the an that various other changes and modifications can be made without departing from the spirit and scope of the invention. It is therefore intended to cover in the appended claims all such changes and modifications that are within the scope of this invention.

### REFERENCE NUMERALS

1 shaver/trimmer

2 cutter head

3 cutter system

4 (stationary) outer cutting element

5 (movable) inner cutting element

6 outer cutting tooth

7 inner cutting tooth

8 perforation

9 perforation

10 flange/edge portion

11 central portion/skin contact surface

12 straight line segment

20 skin bulge

100 handle

101 battery

102 control unit

103 electric drive motor

104 drive train

I first axis

II second axis

III third axis

IV fourth axis

1. Cutter system for an electric shaver or trimmer, comprising an inner cutting element and an outer cutting element forming a pair of cooperating cutting elements with two rows of comb-like outer cutting teeth, each having a tooth tip and a longitudinal extension extending parallel to a first axis (I), said tooth tips of both rows of comb like outer cutting teeth are facing away from each other and with opening slots being provided between those teeth, wherein said cutting elements are movably supported relative to each other, whereby the row of comb-like outer cutting teeth have, at a position of 0.2 mm away from the tooth tip along the first axis (I), a ratio between tooth width in a direction perpendicular to said first axis (I) and a width of an opening slot between two of those adjacent teeth between 1.0 and 2.0, wherein said outer cutting teeth are formed in a substantially rectangular shape with rounded edges, at a position of 0.2 mm away from the tooth tip along the first axis (I) and in a cross section perpendicular to said first axis (I).

2. Cutter system according to claim 1, wherein the at least one row of comb-like outer cutting teeth have, at a position of 0.2 mm away from the tip, a ratio between tooth width in a direction perpendicular to said first axis (I) and width of an opening slot between two adjacent teeth between 1.05 to 1.5, preferably 1.085 and 1.433, preferably about 1.333.

3. Cutter system according to claim 1, wherein said outer cutting teeth have, at a position of 0.2 mm away from the tip, a width of 405+/−50 μm, preferably of 405+/−25 μm.

4. Cutter system according to claim 1, wherein said outer cutting teeth have, at a position of 0.2 mm away from the tip, a pitch between two adjacent teeth from the middle of one tooth tip to the middle of the adjacent tooth tip of 730+/−50 μm, preferably of 730+/−25 μm.

5. Cutter system according to claim 1, wherein said outer cutting teeth are U-shaped.

6. Cutter system according to claim 5, wherein said outer cutting teeth include neighboring portions which are folded back-to-back onto each other to form, in cross section perpendicular to said first axis (I), and said U-shaped tooth tips.

7. Cutter system according to claim 1, wherein said outer cutting teeth have, on a side facing away from the inner cutting element, a smooth flat surface.

8. Cutter system according to claim 1, wherein said rounded edges of said outer cutting teeth tooth tips have a radius between 120 μm and 225 μm, e.g. 210 μm or 200 μm and/or said tooth tips are made by bending and said radius is a bending radius.

9. Cutter system according to claim 1, wherein the teeth, at least at the tooth tips, have a thickness, when viewed in cross section, of less than 1 mm or less than 0.5 mm

10. Cutter system according to claim 1, wherein said outer cutting teeth comprise a tooth root having, on a side facing away from the inner cutting element, a smooth flat surface and on a side facing towards the inner cutting element, a concave surface forming a sharp cutting edge with the side facing away from the inner cutting element.

11. Cutter system according to claim 10, wherein said tooth tip is formed by two side etching and wherein said tooth root is formed by one side etching.

12. Electric shaver or trimmer, comprising a cutter system of claim 1.

13. Electric shaver or trimmer according to claim 12, wherein the cutter system is supported to swivel relative to a handle portion.

14. Cutter system for an electric shaver or trimmer, comprising an inner cutting element and an outer cutting element forming a pair of cooperating cutting elements with two rows of comb-like outer cutting teeth, each having a tooth tip and a longitudinal extension extending parallel to a first axis (I), a second axis (II) which is perpendicular to the first axis (I) defines the direction of movement of the inner cutting element with respect to the outer cutting element and a fourth axis (IV) extends perpendicular to both the first and the second axis (I, II) and extends in a height direction, wherein said tooth tips of the outer teeth of both rows of comb like outer cutting teeth are facing away from each other and wherein said tooth tops of the outer teeth are shaped flat to comprise a straight line segment with a length larger than 0,15 mm parallel to axis (II).

15. Cutter system of claim 14, wherein the length of the straight line segment is larger than 0,2 mm but smaller than 0,4 or 0,5 mm.
